(19) United States
(12) Patent Application Publication
(10) Pub. No.: US 2025/0122952 A1
(43) Pub. Date: Apr. 17, 2025

(54) BALANCE EXPLOSION-PROOF VALVE

(71) Applicant: SHENZHEN EVERWIN PRECISION TECHNOLOGY CO., LTD., SHENZHEN (CN)

(72) Inventors: LIDONG WANG, SHENZHEN (CN); QIUWEN DU, SHENZHEN (CN)

(21) Appl. No.: 19/000,519

(22) Filed: Dec. 23, 2024

Related U.S. Application Data
(63) Continuation of application No. PCT/CN2023/104943, filed on Jun. 30, 2023.

(30) Foreign Application Priority Data
Sep. 29, 2022 (CN) 202211199162.3
Sep. 29, 2022 (CN) 202222599955.6
Sep. 29, 2022 (CN) 202222604417.1
Sep. 29, 2022 (CN) 202222604484.3
Sep. 29, 2022 (CN) 202222604899.0

(51) Int. Cl. F16K 39/02

(52) U.S. Cl. CPC F16K 39/022

(57) ABSTRACT

A balance explosion-proof valve includes a valve body, a pressure relief assembly assembled on the valve body, and an air pressure balance assembly assembled on the pressure relief assembly. The valve body includes an outer ring body, an inner ring body, and connecting arms connected to an inner surface of the outer ring body and an outer surface of the inner ring body. The pressure relief assembly includes a piston pressed against a surface of the outer ring body, a waterproof breathable membrane, an upper cover plate, and a magnetic sheet covering the waterproof breathable membrane. The waterproof breathable membrane is coupled to the piston. The air pressure balance assembly is installed on the piston and passes through the central sleeve hole. The piston includes an inner concave cavity, a pressing step protruding from the inner concave cavity, and an outer ring portion protruding from the pressing step.

### TECHNICAL FIELD

The present disclosure relates to a technical field of explosion-proof of power batteries, and in particular to a balance explosion-proof valve.

### BACKGROUND

A balance explosion-proof valve is configured to maintain a balance of internal and external pressures of a power battery, is configured to relieve a pressure of the power battery in advance, and avoids an explosion of the power battery and safety accidents. Chinese patent application No. 202121092721.1 discloses a balance explosion-proof valve. The balanced explosion-proof valve comprises a valve body, a guide rod passing through the valve body, a spring disposed between the valve body and the guide rod, and a piston fixed to an end of the guide rod. The piston defines an air hole corresponding to a ventilation central hole of the guide rod. A waterproof breathable membrane covering the air hole is mounted on the piston. An air pressure balance assembly is disposed on a lower end of the ventilation central hole. The air pressure balance assembly comprises a sealing gasket, a sealing cover, an upper spring disposed between an upper end of the sealing cover and the guide rod, a support sheet disposed on a lower end surface of the sealing gasket, a lower plugging cover fixed to the lower end of the ventilation central hole, and a lower spring mounted between the lower plugging cover and the support sheet. The sealing gasket and the sealing cover cooperate to block the air-permeable central hole. The lower plugging cover defines a central hole. The balanced explosion-proof valve has following defects.

Firstly, the guide rod and the piston are separated components, and according to a design principle, sealing performance of a joint between the guide rod and the piston must be ensured, otherwise the air pressure balance assembly does not work.

Secondly, a bottom structure of the guide rod is complex, and the guide rod is processed by turning and milling. A complex structure of the guide rod may increase a large number of computer numerical control (CNC) processing steps, causing a significant increase in manufacturing costs.

Vent grooves are defined in an upper surface of an edge of the piston, and the piston is processed by turning and milling. Presentation of the vent grooves may increase an CNC processing amount and the manufacturing costs, and a serrated structure is generally disposed on the upper surface of the edge of the piston, which also increases the CNC processing amount.

### SUMMARY

In view of this, it is necessary to provide a balance explosion-proof valve with lower manufacturing cost and effectively reduced processing difficulty.

In order to solve above technical problems, the present disclosure provides a balance explosion-proof valve. The balance explosion-proof valve comprises a valve body, a pressure relief assembly assembled on an upper side of the valve body, and an air pressure balance assembly assembled on a lower side of the pressure relief assembly. The valve body comprises an outer ring body, an inner ring body, and connecting arms. The connecting arms are connected to an inner surface of the outer ring body and an outer surface of the inner ring body. Pressure relief holes are defined between the outer ring body and the inner ring body. A central sleeve hole is defined in the inner ring body. The central sleeve hole penetrates through the inner ring body in a vertical direction. The pressure relief assembly comprises a piston pressed against a surface of the outer ring body, a waterproof breathable membrane, and an upper cover plate covering the waterproof breathable membrane. A periphery of the waterproof breathable membrane is coupled to the piston. The air pressure balance assembly is mounted on a lower side of the piston and passes through the central sleeve hole. The piston comprises an inner concave cavity, a pressing step, and an outer ring portion. The pressing step protrudes upward from a periphery of the inner concave cavity. The outer ring portion protrudes upward from an outer edge of the pressing step. The periphery of the waterproof breathable membrane is fixed to the pressing step and covers the inner concave cavity. The waterproof breathable membrane is communicated with an outside through the upper cover plate or a space defined between the upper cover plate and the piston.

In order to solve the above technical problems, the present disclosure provides a balance explosion-proof valve. The balance explosion-proof valve comprises a valve body, a pressure relief assembly assembled on an upper side of the valve body, and an air pressure balance assembly assembled on a lower side of the pressure relief assembly. The valve body comprises an outer ring body, an inner ring body, and connecting arms. The connecting arms are connected to an inner surface of the outer ring body and an outer surface of the inner ring body. Pressure relief holes are defined between the outer ring body and the inner ring body. A central sleeve hole is defined in the inner ring body. The central sleeve hole penetrates through the inner ring body in a vertical direction. The pressure relief assembly comprises a piston pressed against a surface of the outer ring body, a waterproof breathable membrane, and an upper cover plate covering the waterproof breathable membrane. A periphery of the waterproof breathable membrane is coupled to the piston. The air pressure balance assembly comprises a guide rod connected to a lower side of the piston, a lower plugging cover connected to a lower end of the guide rod, and a balance valve. The balance valve is mounted in the guide rod and the lower plugging cover. A central hole is defined in the guide rod and penetrates through the guide rod in the vertical direction. The central hole is communicated with the waterproof breathable membrane. An outer protruding ring protrudes from a periphery of the lower plugging cover in the radial direction. A pressure relief spring is sleeved on an outer side of the guide rod. The pressure relief spring is supported between the inner ring body and the outer protruding ring.

In order to solve the above technical problems, the present disclosure provides a balance explosion-proof valve. The valve body comprises an outer ring body, an inner ring body, and connecting arms. The connecting arms are connected to an inner surface of the outer ring body and an outer surface of the inner ring body. Pressure relief holes are defined between the outer ring body and the inner ring body. A central sleeve hole is defined in the inner ring body. The central sleeve hole penetrates through the inner ring body in a vertical direction. The pressure relief assembly comprises a piston pressed against a surface of the outer ring body, a waterproof breathable membrane, and an upper cover plate covering the waterproof breathable membrane. A periphery of the waterproof breathable membrane is coupled to the piston. The air pressure balance assembly is mounted on a lower side of the piston and passes through the central sleeve hole. The piston comprises an inner concave cavity, a pressing step, and an outer ring portion. The pressing step protrudes upward from a periphery of the inner concave cavity. The outer ring portion protrudes upward from an outer edge of the pressing step. The periphery of the waterproof breathable membrane is fixed to the pressing step and covers the inner concave cavity. A bottom surface of the outer ring portion is pressed against a first sealing ring on the surface of the outer ring body. The upper cover plate defines vent grooves corresponding to the outer ring portion. The vent grooves communicate the waterproof breathable membrane with an outside.

In the present disclosure, an outer diameter of the magnetic sheet is increased to form the connecting outer ring, so that the connecting outer ring is clamped between the outer ring portion and the upper cover plate. The notches of the magnetic sheet replaces the vent grooves and plays a ventilation function, thereby simplifying a structure of the piston and a structure of the upper cover plate. Moreover, the magnetic sheet has a simple structure and is directly formed by stamping, which has a lower manufacturing cost.

In the present disclosure, the lower plugging cover is disposed under the guide rod, and the pressure relief spring is supported by the outer protruding ring of the lower plugging cover, which effectively reduces structural complexity of the guide rod and reduces difficulty of processing the guide rod and the piston.

In the present disclosure, the vent grooves are defined in the upper cover plate, and the upper cover plate has a simple structure and is manufactured by stamping and stretching processes. However, the piston needs to be made by precision machining. vent grooves and the rough surfaces thereof in the prior art are defined in the piston, which lead to a high manufacturing cost. Compared with the prior art, the technical solution disclosed in the present disclosure reduces the manufacturing cost and enhance product competitiveness.

### BRIEF DESCRIPTION OF DRAWINGS

FIG. 1 is a perspective schematic diagram of a balance explosion-proof valve according to a first embodiment of the present disclosure where the balance explosion-proof valve is assembled on a battery shell of a power battery.

FIG. 2 is a perspective schematic diagram of the balance explosion-proof valve according to the first embodiment of the present disclosure.

FIG. 3 is a perspective exploded schematic diagram of the balance explosion-proof valve according to the first embodiment of the present disclosure.

FIG. 4 is a cross-sectional schematic diagram of the balance explosion-proof valve shown in an exploded state in FIG. 3.

FIG. 5 is a perspective schematic diagram of a piston of the balance explosion-proof valve according to the first embodiment of the present disclosure.

FIG. 6 is a perspective exploded schematic diagram of the balance explosion-proof valve according to the first embodiment of the present disclosure, where an upper cover plate is removed.

FIG. 7 is a cross-sectional schematic diagram of the balance explosion-proof valve shown in an assembled state according to the first embodiment of the present disclosure.

FIG. 8 is a schematic diagram of the balance explosion-proof valve in a negative pressure state according to the first embodiment of the present disclosure.

FIG. 9 is a schematic diagram of the balance explosion-proof valve in a positive pressure state according to the first embodiment of the present disclosure.

FIG. 10 is a schematic diagram of the balance explosion-proof valve in a pressure relief state according to the first embodiment of the present disclosure.

FIG. 11 is a cross-sectional schematic diagram of the balance explosion-proof valve in the assembled state according to a second embodiment of the present disclosure.

FIG. 12 is a cross-sectional schematic diagram of the balance explosion-proof valve in the exploded state according to a third embodiment of the present disclosure.

FIG. 13 is a schematic diagram of the piston, a magnetic sheet, and the upper cover plate valve of the balance explosion-proof valve according to the third embodiment of the present disclosure.

FIG. 14 is another schematic diagram of the piston, the magnetic sheet, and the upper cover plate valve of the balance explosion-proof valve according to the third embodiment of the present disclosure.

FIG. 15 is a schematic diagram of the magnetic sheet and the upper cover plate valve, shown in an assembled state, of the balance explosion-proof valve according to the third embodiment of the present disclosure.

FIG. 16 is a cross-sectional schematic diagram of the piston, a waterproof breathable membrane, a pressing ring, a magnetic sheet, and the upper cover plate valve, shown in the assembled state, of the balance explosion-proof valve according to the third embodiment of the present disclosure.

FIG. 17 is a schematic diagram of the piston, the magnetic sheet, and the upper cover plate valve of the balance explosion-proof valve according to a fourth embodiment of the present disclosure.

FIG. 18 is another schematic diagram of the piston, the magnetic sheet, and the upper cover plate valve of the balance explosion-proof valve according to the fourth embodiment of the present disclosure.

FIG. 19 is a cross-sectional schematic diagram of the piston, the waterproof breathable membrane, the pressing ring, the magnetic sheet, and the upper cover plate valve, shown in the assembled state, of the balance explosion-proof valve according to the fourth embodiment of the present disclosure.

FIG. 20 is a schematic diagram of the piston, the magnetic sheet, and the upper cover plate valve of the balance explosion-proof valve according to a fifth embodiment of the present disclosure.

### DETAILED DESCRIPTION

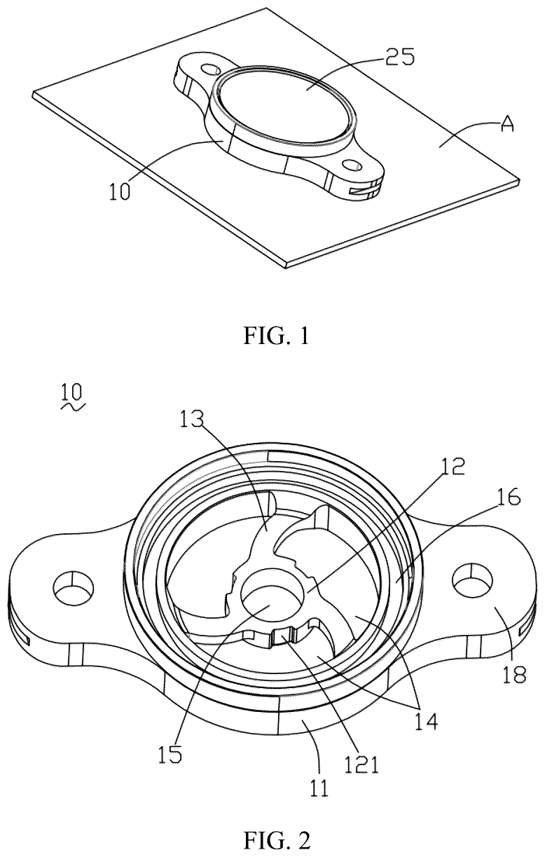

As shown in FIG. 1, the balance explosion-proof valve of the present disclosure is applied to a power battery, and the balance explosion-proof valve is installed on a battery shell A of the power battery. The balance explosion-proof valve mainly realizes two functions. A first function thereof is to balance internal and external pressures of the power battery and realize waterproof and dustproof effects when the internal pressure of the power battery fluctuates within a small range. A second function thereof is to quickly release the internal pressure of the power battery when the internal pressure of the power battery increases sharply, so as to realize a pressure relief effect to prevent the power battery from exploding.

### Embodiment 1

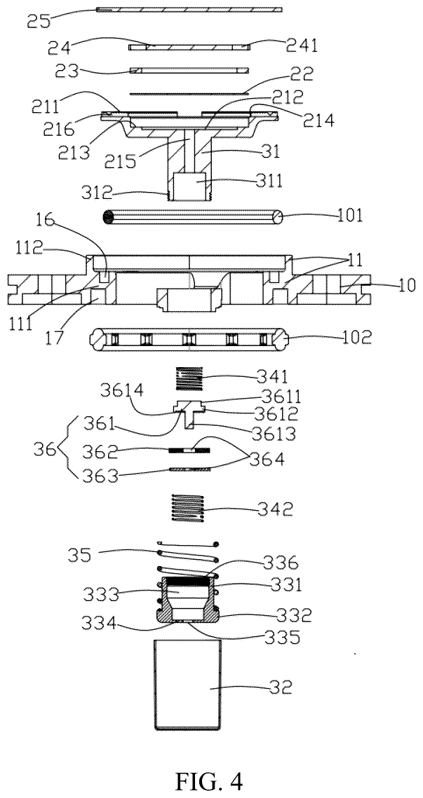

As shown in FIGS. 1-5 and 7, a balance explosion-proof valve of the embodiment comprises a valve body 10, a pressure relief assembly 20, and an air pressure balance assembly 30. The pressure relief assembly 20 and the air pressure balance assembly 30 are assembled in the valve body 10.

The battery housing A comprises a mounting hole, and the valve body 10 is fixed to a periphery of the mounting hole. The valve body 10 comprises an outer ring body 11, an inner ring body 12, and connecting arms 13. The connecting arms 13 connect the outer ring body 11 to the inner ring body 12.

The outer ring body 11 comprises an outer ring lower portion 111 and an outer ring upper portion 112 extending upward from an outer edge of the outer ring lower portion 111. A thickness of the outer ring lower portion 111 is greater than a thickness of the outer ring upper portion 112. An upper sealing ring groove 16 is defined in the outer ring lower portion 11. The upper sealing ring groove 16 is located within an inner side of the outer ring upper portion 112. A lower sealing ring groove 17 is defined in a bottom side of the outer ring lower portion 111, Two fixing ears 18 are integrally formed with the outer ring lower portion 11. The fixing ears 18 respectively extend from an outer side of the outer ring body 11, and the valve body 10 is fixed to the battery housing A through the fixing ears 18.

Outer grooves 121 are defined in an outer peripheral surface of the inner ring body 1 in a vertical direction. The connecting arms 13 are connected to an inner surface of the outer ring body 11 and an outer surface of the inner ring body 12. The valve body 10 is processed by an integral lathe and is made of metal, and a bottom surface of the inner ring body 12 is lower than a bottom surface of the outer ring body 11. A first sealing ring 101 is mounted in the upper sealing ring groove 16, and a second sealing ring 102 is installed in the lower sealing ring groove 17. A top surface of the inner ring body 12 does not extend the upper sealing ring groove 16. Pressure relief holes 14 are defined between the outer ring body 11 and the inner ring body 12. A central sleeve hole 15 is defined in the inner ring body 12. The central sleeve hole 15 penetrates through the inner ring body 12 in the vertical direction. The pressure relief holes 14 are spaced apart by the connecting arms 13.

The pressure relief assembly 20 comprises a piston 21 elastically pressed against the first sealing ring 101, a waterproof breathable membrane 22, a pressing ring 23 crimping the waterproof breathable membrane 22 onto the piston 21, a magnetic sheet 23 mounted on the piston 21, and an upper cover plate 25 attached to an upper surface of the piston 21.

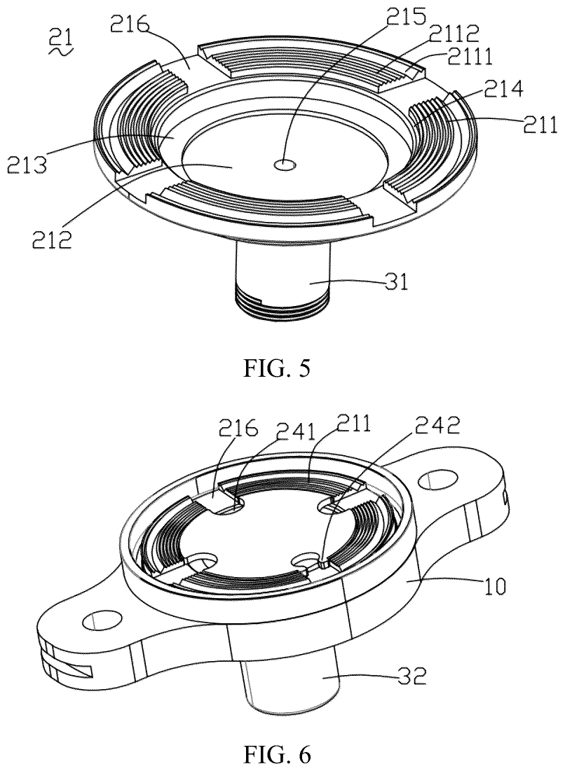

As shown in FIG. 5, the piston 21 comprises an inner concave cavity 212, a pressing step 213, a clamping step 214, and an outer ring portion 211. On a horizontal plane, the inner concave cavity 212, the pressing step 213, the clamping step 214, and the outer ring portion 211 are disposed in sequence from bottom to top. That is, a surface of the outer ring portion 211 is higher than a surface of the clamping step 214, the surface of the clamping step 214 is higher than a surface of the pressing step 213, and the surface of the pressing step 213 is higher than a surface of the inner concave cavity 212. A bottom surface of the outer ring portion 211 is higher than an upper surface of the pressing step 213. The bottom surface of the outer ring portion 211 is pressed on the first sealing ring 101 and is supported by a surface of the outer ring lower portion 111. The bottom surface of the outer ring portion 211 and the outer ring lower portion 111 clamp the first sealing ring 101 to realize sealing, and a clamping force between the outer ring portion 211 and the outer ring lower portion 111 is an elastic force of a pressure relief spring 35. Specifically, a lower portion of the inner concave cavity 212 is connected to a limiting piece, or the lower portion of the inner concave cavity 212 extends downward to form the limiting component, and the pressure relief spring 35 is sleeved on an outer side of the limiting piece. The pressure relief spring 35 is clamped between a lower end of the inner ring body 12 and the limiting piece, so that the piston 21 is tightened by the elastic force on an upper side of the outer ring lower portion 111.

As shown in FIG. 10, when the internal pressure of the power battery is greater than a threshold of the elastic force of the pressure relief spring 35, high-pressure gas in the power battery pushes the piston 21 upward to move away from the valve body 10, so that the high-pressure gas overflows outward through the pressure relief holes 14 to release the internal pressure of the power battery, thereby preventing the internal pressure of the battery from being too high and preventing the power battery from exploding.

Vent grooves 216 are defined in an upper surface of the outer ring portion 211 in a radial direction, and the upper surface of the outer ring portion 211 is roughened to form rough surfaces 2111 and rough surfaces 2112. For example, jagged grooves are defined in a circumferential direction, and the jagged grooves comprise jagged grooves 2111 and jagged groove 2112. The jagged grooves 2111 is relatively deep and the jagged groove 2112 are relatively shallow. A bottom portion of the inner concave cavity 212 of the piston 21 extends downward to form a guide rod 31. A lower end of the guide rod 31 is hollow and defines a balance cavity 311 extending upward. A threaded portion 312 is disposed on an outer side of the lower end of the guide rod 31. A central hole 215 communicating the inner concave cavity 212 and the balance cavity 311 is defined in a middle portion of the inner concave cavity 212. The central hole 215 penetrates through the inner concave cavity 212 in the vertical direction.

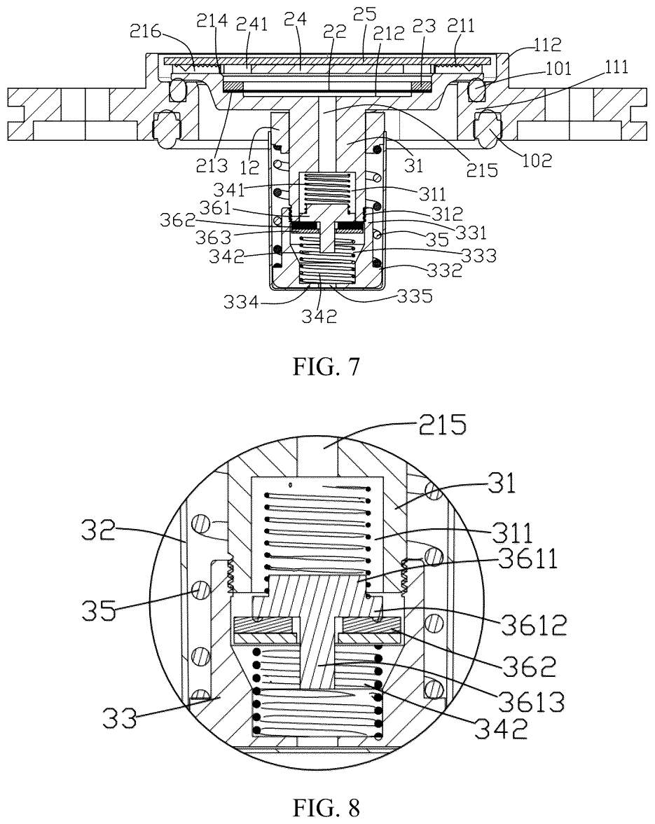

As shown in FIGS. 6 and 7, the waterproof breathable membrane 22 is pressed on the pressing step 213 by the pressing ring 23 and covers the inner concave cavity 212, so that the central hole 215 is sealed by the waterproof breathable membrane 22. An outer diameter of the pressing ring 23 is slightly greater than an inner diameter of the pressing step 213. The pressing ring 23 is riveted onto the pressing step 213 and fixes a periphery of the waterproof breathable membrane 22. The magnetic sheet 24 is pressed into the clamping step 214. Notches 241 are defined in a periphery of the magnetic sheet 24 and are respectively corresponding to positions of the vent grooves 216. The notches 214 communicate an upper side of the waterproof breathable membrane 22 with the vent grooves 216. Two sides of at least one of the notches 214 protrude in the radial direction to from two elastic clamping blocks 242. The elastic clamping blocks 242 of the at least one of the notches 214 protrude radially and are clamped in one of the vent grooves 216 to strengthen the fixation and positioning of the magnetic sheet 24. The upper cover plate 25 is bonded to the upper surface of the outer ring portion 211. The rough surface 2111 and the rough surfaces 2112 on the upper surface of the outer ring portion 211 are configured to accommodate an adhesive, so that the upper cover plate 25 is tightly attached to the rough surfaces 2111 and the rough surfaces 2112.

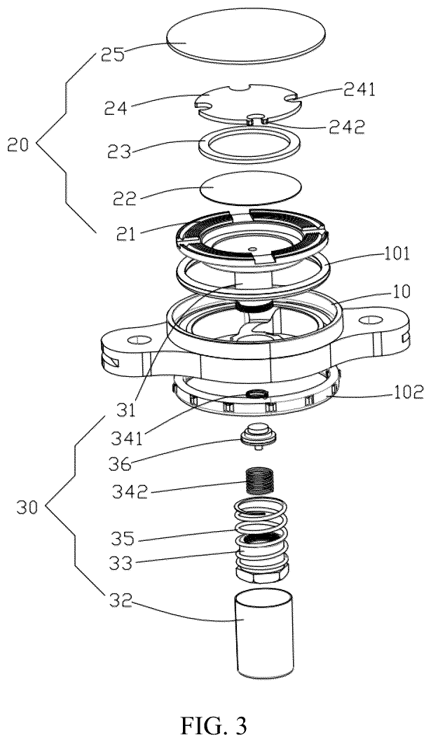

As shown in FIGS. 3, 4, and 7, the air pressure balance assembly 30 comprises the guide rod 31, a lower plugging cover 33 fixed to the bottom portion of the guide rod 31, a balance valve 36 installed between the guide rod 31 and the lower plugging cover 33, an upper spring 341, a lower spring 342, and a protective shell 32.

An upper end of the lower plugging cover 33 is hollow and defines a plugging cover cavity 333. A threaded portion 336 is defined on an inner wall of the plugging cover cavity 333, so that the lower plugging cover 33 is screwed with the threaded portion 312 disposed on the lower end of the guide rod 31. Two ends of the upper spring 341 respectively abut against a top portion of the balance cavity 311 and an upper surface of the balance valve 36. Two ends of the lower spring 342 respectively abut against a bottom portion of the balance valve 36 and a bottom surface of the plugging cover cavity 333.

The balance valve 36 comprises a balance plug 361, a sealing gasket 362, and a rigid gasket 363. The balance plug 361 comprises a balance plug body 3612, an upper limiting portion 3611, and an extension rod 3613. The upper limiting portion 3611 is formed by protruding upward from a top portion of the balance plug body 3612. The extension rod 3613 extends downward from a lower side of the balance plug body 3612. An outer diameter of the balance plug body 3612 is less than an inner diameter of the balance cavity 311. An outer diameter of the upper limiting portion 3611 is less than the outer diameter of the balance plug body 3612. An outer diameter of the extension rod 3613 is less than the outer diameter of the upper limiting portion 3611. One end of the upper spring 341 is sleeved on an outer side of the upper limiting portion 3611. The balance plug body 3612 is plugged into the balance cavity 311. An outer peripheral edge of a bottom surface of the balance plug body 3612 protrudes downward to form a rim 3614.

Via holes 364 are respectively formed in a middle portion of the sealing gasket 362 and a middle portion of the rigid gasket 363. The sealing gasket 362 and the rigid gasket 363 are sleeved on the extension rod 3613 through the via holes 364. An inner diameter of each of the via holes 364 is greater than the outer diameter of the extension rod 3613. The sealing gasket 362 is made from a flexible material. An outer diameter of the sealing gasket 362 is greater than an inner diameter of the balance cavity 311 and less than an outer diameter of the guide rod 31 or an inner diameter of the plugging cover cavity 333. An upper end of the lower spring 342 abuts against the rigid gasket 363. The sealing gasket 362 is pressed and fitted on an end surface of the guide rod 31 by the rigid gasket 363 and the lower spring 342 for sealing.

The lower plugging cover 33 further comprises a cavity outer wall 331, a cavity bottom wall 334, an outer protruding ring 332 protruding from a periphery of a lower side of the cavity outer wall 331, and a through hole 335 penetrating through the cavity bottom wall 334 in the vertical direction. Two ends of the pressure relief spring 35 are respectively supported on the inner ring body 12 and the outer protruding ring 332. The guide rod 31 and the lower plugging cover 33 constitute the limiting piece mentioned above.

The protective shell 32 is a cup-shaped structure. The protective shell 32 is mounted on a periphery of the inner ring body 12. Specifically, the protective shell 32 protects the guide rod 31 and the lower plugging cover 33 therein. An inner wall surface of the protective shell 32 is bonded to an outer surface of the inner ring body 12. The outer groove 121 communicate an interior of the power battery with a space enclosed by the protective shell 32.

The air pressure balance assembly 30 is configured to balance the internal and external pressures of the power battery. That is, when the internal pressure of the power battery is negative or the internal pressure is less than a pressure relief threshold, the internal and external pressures of the power battery are kept balanced.

As shown in FIG. 8, when a negative pressure inside the power battery reaches a critical value, that is, when the internal pressure of the power battery overcomes the elastic force of the lower spring 342, the external pressure pushes the balance valve 36 downward to compress the lower spring 342, the sealing gasket 36 is not in contact with the end surface of the guide rod 31 and does not play a sealing role, and external gas enters the piston 21 through the vent groove 216. After the external gas penetrates through the waterproof breathable membrane 22, the external gas floes downward to reach the balance cavity 311 from the central hole 215 and enters the plugging cover cavity 333 along the periphery of the balance valve 36. Then the external gas enters the power battery through the through hole 335 and the outer grooves 121 to achieve pressure balance.

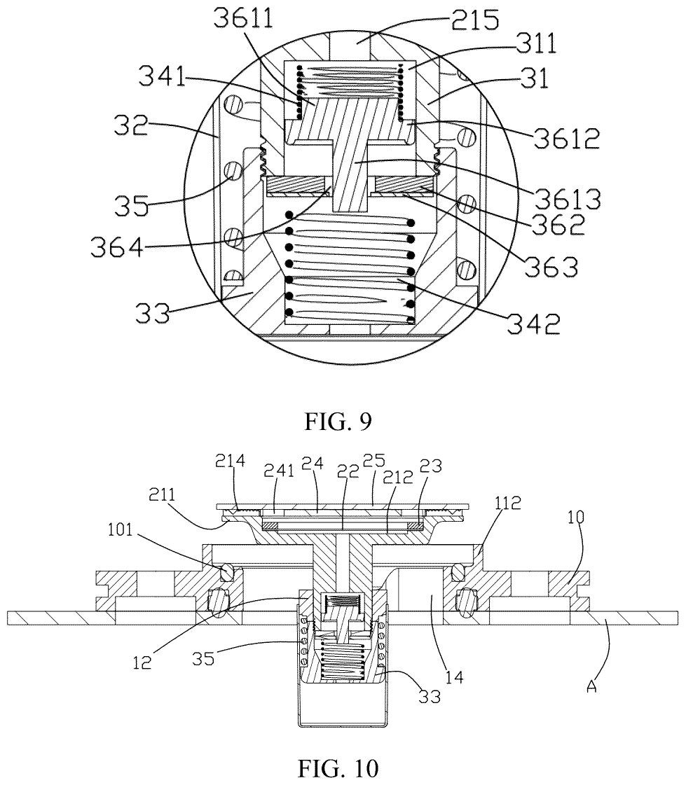

As shown in FIG. 9, when the positive pressure inside the power battery reaches the pressure relief threshold, that is, when the internal pressure of the power battery overcomes the elastic force of the upper spring 341, the internal pressure of the power battery pushes the balance valve 36 upward, so that the balance plug 361 of the balance valve 36 rises upward. At this time, the air flow inside the power battery enters the balance cavity 311 from the plugging cover cavity 333 along gaps between the extension rod 3613 and the via holes 364, and then flows out through a gap between the balance plug 361 and an inner wall surface of the balance cavity 311, the central hole 215, the waterproof breathable membrane 22, and the vent grooves 216, so as to balance the internal and external pressures of the power battery.

In Embodiment 1, the guide rod 31 and the piston 21 are integrally processed, which avoids a need to deal with a sealing problem between the guide rod 31 and the piston 21 when the guide rod 31 and the piston 21 are separated structures, and increases stability of a structure of the present disclosure. Meanwhile, the lower plugging cover 33 is fixed to the lower end of the guide rod 31 and supports one end of the pressure relief spring 35, which effectively reduces a structural complexity of the balance cavity 311 of the guide rod 31 and reduces difficulty of processing the guide rod 31 and the piston 21.

### Embodiment 2

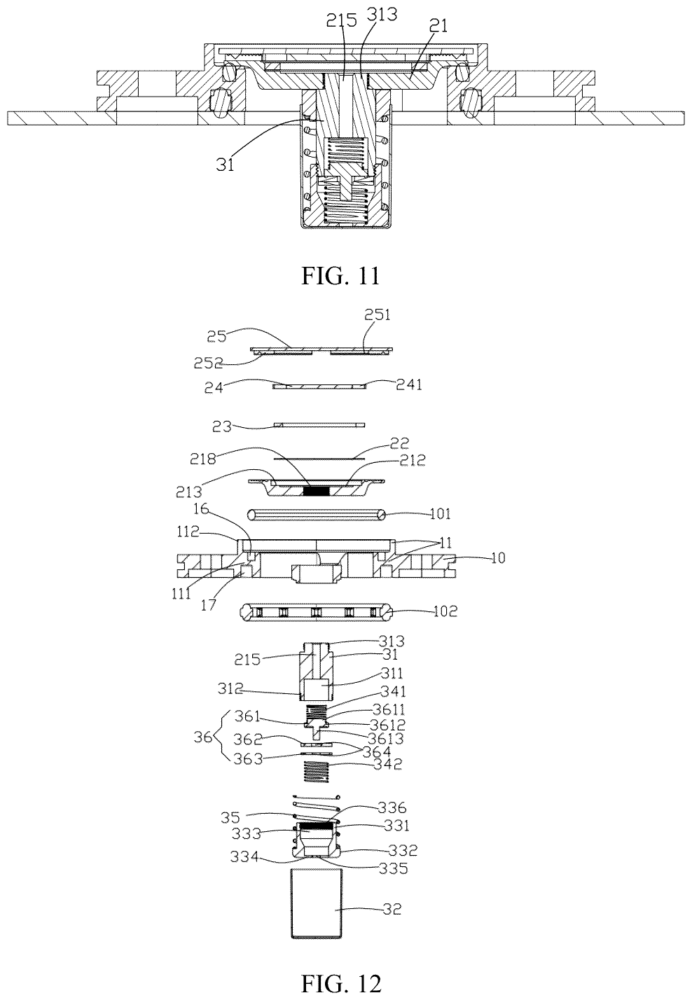

As shown in FIGS. 11 and 12, compare with Embodiment 1, the guide rod 31 and the piston 21 of the embodiment are separated structures. A threaded hole 218 is defined in a middle portion of the inner concave cavity 212, and a connecting head 313 is disposed on an upper edge of the guide rod 31, and the connecting head 313 is screwed with the threaded hole 218. In the embodiment, when the guide rod 31 is screwed with the threaded hole 218, a sealing ring is clamped between the guide rod 31 and the piston 21 to achieve sealing performance between the piston 21 and the guide rod 31. Alternatively, waterproof adhesive is applied at a junction of the piston 21 and the guide rod 31 to achieve sealing. In the embodiment, the central hole 215 penetrates through the guide rod 31 in the vertical direction.

### Embodiment 3

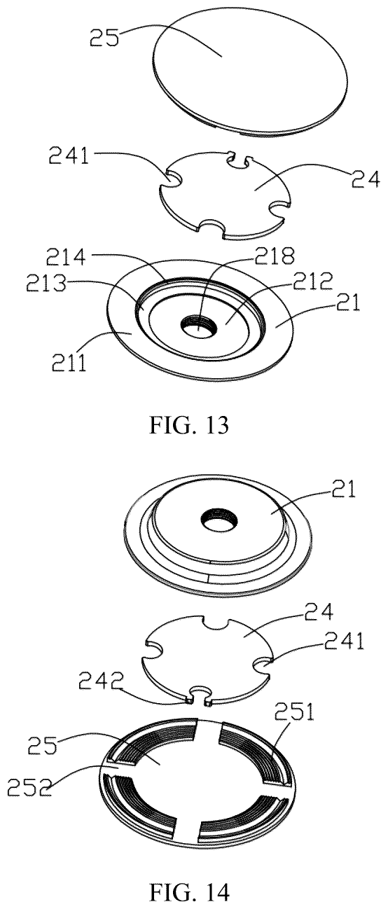

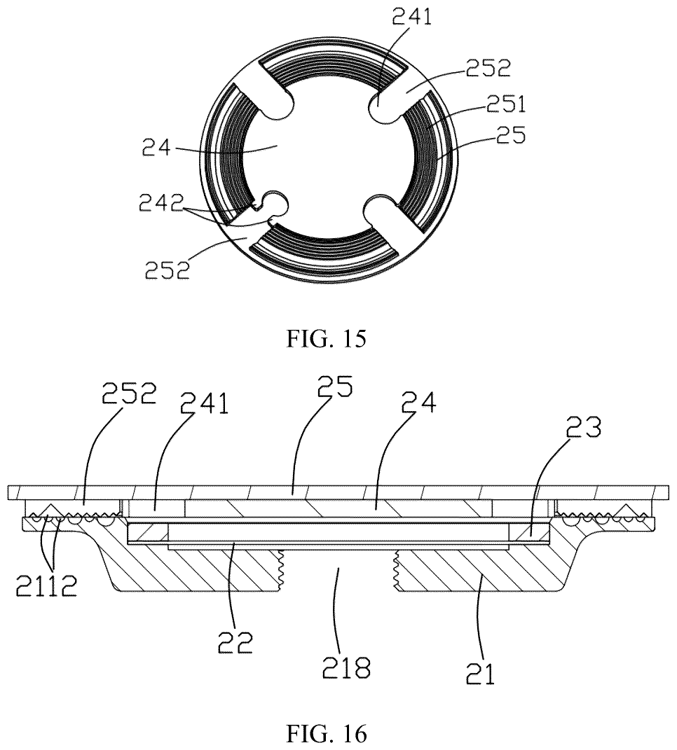

As shown in FIGS. 12-16, compare with Embodiment 2, there are no rough surfaces 2111, rough surfaces 2112, and the vent grooves 216 on the outer ring portion 211 of the piston 21 in the embodiment. Instead, the rough surfaces and the vent grooves are defined on the upper cover plate 25. Specifically, a periphery of the upper cover plate 25 protrudes downward to form a lower protruding portion 251, a surface of the lower protruding portion 251 forms the rough surfaces, and the vent grooves 252 penetrate through the lower protruding portion 251 in the radial direction.

The magnetic sheet 24 is clamped in the upper cover plate 25, that is, the elastic clamping blocks 242 are clamped in one of the vent grooves 252. The elastic clamping blocks 242 are a pair of elastic components. The elastic clamping blocks 342 are riveted into the one of the vent grooves 252 to fix the magnetic sheet 24 on the upper cover plate 25, and the notches 241 are located above the waterproof breathable membrane 22 in the vertical direction to achieve ventilation.

In the embodiment, the vent grooves 252 are disposed on the upper cover plate 25, and the upper cover plate 25 has a simple structure and is manufactured by stamping and stretching processes, while the piston 21 needs to be precisely processed by CNC. A processing cost of the vent grooves 216, the rough surfaces 2111, and the rough surfaces 2112 in Embodiment 2 is relatively high. Compared with a technical solution of configuring the vent grooves 252 on the piston 21, a manufacturing cost of a technical solution in the embodiment is greatly reduced, thereby enhancing competitiveness of the balance explosion-proof valve.

In the embodiment, a middle portion of the upper cover plate 25 may also be stamped and stretched upward to form a concave portion extending upward, and an edge portion of the upper cover plate 25 is served as the lower protruding portion 251 and the vent grooves 252 is defined thereon.

### Embodiment 4

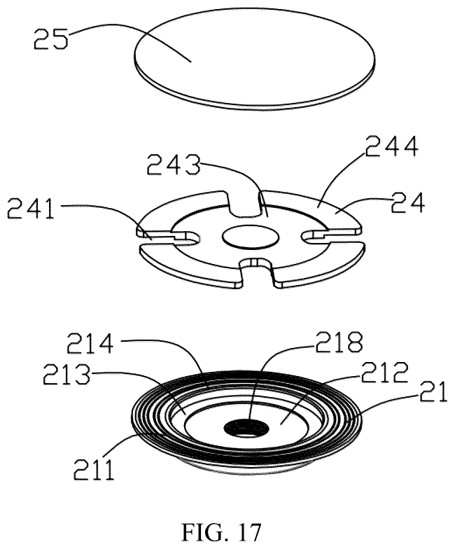

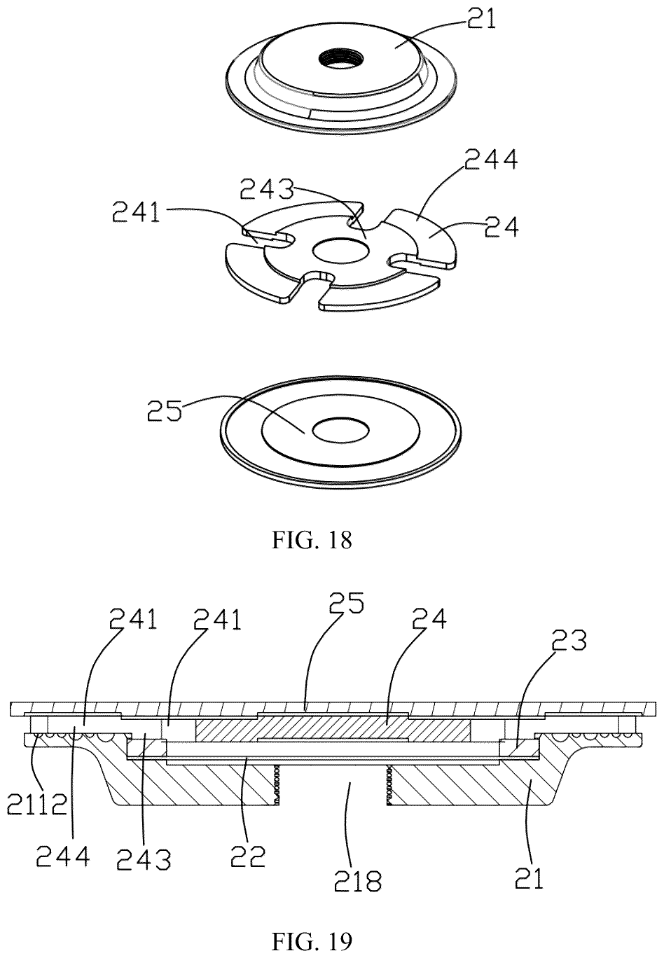

As shown in FIGS. 17-19, compared with Embodiment 2, the vent grooves 216 of the embodiment are not defined in the outer ring portion 211 of the piston 21.

The upper surface of the outer ring portion 211 forms the rough surfaces 2111, and the rough surfaces 2112 to accommodate the adhesive. The outer diameter of the magnetic sheet 24 is increased to at least partially cover the upper surface of the outer ring portion 211, so that the magnetic sheet 24 comprises a middle portion 243 suspended above the waterproof breathable membrane 22 and a connecting outer ring 244 formed on a periphery of the middle portion 243 of the magnetic sheet 24. The notches 241 penetrate through the connecting outer ring 244 radially outward from the middle portion 243 of the magnetic sheet 24. The middle portion 243 of the magnetic sheet 24 is recessed downward to form a recessed structure, so that a lower portion of the middle portion 243 of the magnetic sheet 24 is snapped into an upper portion of the pressing step 213 for positioning. The connecting outer ring 244 is clamped between the outer ring portion 211 and the upper cover plate 25 and is bonded to the outer ring portion 211 and the upper cover plate 25. Edges of the outer ring portion 211 and the upper cover plate 25 comprises the rough surfaces or the jagged structures to accommodate the adhesive and enhance the bonding force. The notches 241 radially communicate the waterproof breathable membrane 22 with the outside to achieve ventilation.

In the embodiment, the outer diameter of the magnetic sheet 24 is increased to form the connecting outer ring 244, so that the connecting outer ring 244 is clamped between the outer ring portion 211 and the upper cover plate 25. The notches 241 of the magnetic sheet 24 replaces the vent grooves and plays a ventilation function, thereby simplifying a structure of the piston 21 and a structure of the upper cover plate 25. Moreover, the magnetic sheet 24 has a simple structure and is directly formed by stamping, which has a lower manufacturing cost.

### Embodiment 5

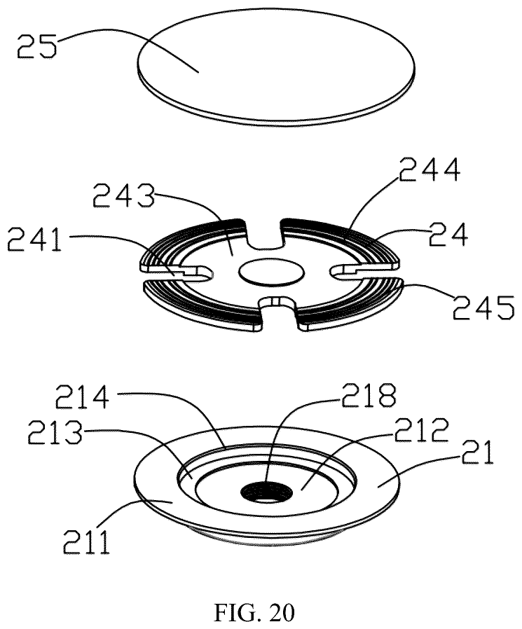

As shown in FIG. 20, compared with Embodiment 4, there are no rough surfaces on edge of the upper cover plate 25 and the surface of the outer ring portion 211 of the piston 21, but the connecting outer ring 244 of the magnetic sheet 24 is punched to form folds 245, so that upper and lower surfaces of the connecting outer ring 244 of the magnetic sheet 24 from the rough surfaces or the jagged structure. Thus, the connecting outer ring 244, the upper cover plate 25, and the outer ring portion 211 of the piston 21 are firmly bonded.

In the embodiment, the folds 245 are punched on the connecting outer ring 244 of the magnetic sheet 24 to form the rough surfaces on the upper and lower surfaces of the connecting outer ring 244. Compared with separately configuring the rough surfaces on the outer ring portion 211 and the upper cover plate 25, a manufacturing cost thereof is lower.

The above description is only optional embodiments of the present disclosure and is not intended to limit the present disclosure. For those skilled in the art, the present disclosure may have various changes and variations. Any modification, equivalent substitution, improvement, etc. made within the spirit and principle of the present disclosure shall be comprised in the scope of the claims of the present disclosure.

What is claimed is:

1. A balance explosion-proof valve, comprising:
a valve body;
a pressure relief assembly assembled on an upper side of the valve body; and
an air pressure balance assembly assembled on a lower side of the pressure relief assembly;
wherein the valve body comprises an outer ring body, an inner ring body, and connecting arms, wherein the connecting arms are connected to an inner surface of the outer ring body and an outer surface of the inner ring body, pressure relief holes are defined between the outer ring body and the inner ring body, a central sleeve hole is defined in the inner ring body, and the central sleeve hole penetrates through the inner ring body in a vertical direction;
wherein the pressure relief assembly comprises a piston pressed against a surface of the outer ring body, a waterproof breathable membrane, and an upper cover plate covering the waterproof breathable membrane;
wherein a periphery of the waterproof breathable membrane is connected to the piston, the air pressure balance assembly is mounted on a lower side of the piston and passes through the central sleeve hole, and the piston comprises an inner concave cavity, a pressing step, and an outer ring portion;
wherein the pressing step protrudes upward from a periphery of the inner concave cavity, the outer ring portion protrudes upward from an outer edge of the pressing step, the periphery of the waterproof breathable membrane is fixed to the pressing step and covers the inner concave cavity, and the waterproof breathable membrane is communicated with an outside through the upper cover plate or a space defined between the upper cover plate and the piston.

2. The balance explosion-proof valve according to claim 1, wherein the balance explosion-proof valve further comprises a magnetic sheet clamped between the upper cover plate and the piston, notches are formed in a periphery of the magnetic sheet, the notches communicate the waterproof breathable membrane with the outside, the magnetic sheet comprises a middle portion and a connecting outer ring integrally extending outward from the middle portion in a radial direction, the connecting outer ring is clamped between the outer ring portion and the upper cover plate, and the notches extend outward from the middle portion of magnetic sheet to penetrate the connecting outer ring in the radial direction, so that the waterproof breathable membrane is communicated with the outside.

3. The balance explosion-proof valve according to claim 2, wherein the middle portion of the magnetic sheet is formed by stamping the magnetic sheet downward, an inner edge of the outer ring portion of the piston is recessed downward to form a clamping step, and the middle portion of the magnetic sheet is clamped into the clamping step.

4. The balance explosion-proof valve according to claim 3, wherein inner sides of the notches are disposed above the waterproof breathable membrane, outer sides of the notches are communicated with the outside, an upper surface of the connecting outer ring is bonded to a surface of the upper cover plate, and a lower surface of the connecting outer ring is bonded to a surface of the outer ring portion.

5. The balance explosion-proof valve according to claim 4, wherein folds are defined on the connecting outer ring, and the folds are formed by stamping, so that the upper surface and the lower surface of the connecting outer ring form rough surfaces, and the rough surfaces of the connecting outer ring are configured to accommodate an adhesive.

6. The balance explosion-proof valve according to claim 5, wherein the pressure relief assembly further comprises a pressing ring, the pressing ring is configured to compress the waterproof breathable membrane on the pressing step, an outer diameter of the pressing ring is not less than an inner diameter of the pressing step, and the pressing ring is riveted into the pressing step to compress the waterproof breathable membrane.

7. The balance explosion-proof valve according to claim 6, wherein the outer ring body comprises an outer ring lower portion and an outer ring upper portion extending upward from an outer edge of the outer ring lower portion, a thickness of the outer ring lower portion is greater than a thickness of the outer ring upper portion, an upper sealing ring groove is defined in the outer ring lower portion, the upper sealing ring groove is located in an inner side of the outer ring upper portion, a first sealing ring is mounted in the upper sealing ring groove, and a bottom surface of the outer ring portion is compressed on the first sealing ring.

8. The balance explosion-proof valve according to claim 7, wherein the outer ring upper portion is disposed around the outer ring portion, the magnetic sheet, and the upper cover plate; wherein the balanced explosion-proof valve is configured to be mounted on a battery shell of a power battery, a lower sealing ring groove is defined in a bottom side of the outer ring lower portion, a second sealing ring is mounted in the lower sealing ring groove, the second sealing ring is clamped between the outer ring lower portion and the battery shell, and the second sealing ring is sealed by the battery shell.

9. The balance explosion-proof valve according to claim 2, wherein the air pressure balance assembly comprises a guide rod passing through the central sleeve hole, a lower plugging cover screwed to a lower end of the guide rod, and a balance valve;
wherein the balance valve is mounted in the guide rod and the lower plugging cover, a balance cavity extending upward is defined in the lower end of the guide rod, the balance valve is mounted in the balance cavity and the plugging cover cavity, and a plugging cover cavity extending downward is defined in the lower plugging cover, a central hole is defined in the lower plugging cover and penetrates through the lower plugging cover in the vertical direction, the central hole communicates the waterproof breathable membrane with the balance cavity, an outer protruding ring protrudes from a periphery of the lower plugging cover in the radial direction, a pressure relief spring is sleeved on an outer side of the guide rod, and the pressure relief spring is supported between the inner ring body and the outer protruding ring of the lower plugging cover.

10. The balance explosion-proof valve according to claim 9, wherein a threaded portion is disposed on a periphery of the lower end of the guide rod, the lower plugging cover further comprises a cavity outer wall surrounding the plugging cover cavity, a cavity bottom wall, and a through hole penetrating through the cavity bottom wall in the vertical direction, a threaded portion is disposed on an inner wall surface of an upper end of the plugging cover cavity, the threaded portion of the lower plugging cover is screwed with the threaded portion on the periphery of the lower end of the guide rod, and the outer protruding ring protrudes outward from a lower end of the cavity outer wall in a radial direction.

11. The balance explosion-proof valve according to claim 10, wherein the balance valve comprises a balance plug, a sealing gasket, a rigid gasket, an upper spring, and a lower spring; wherein an outer diameter of the sealing gasket is greater than a diameter of the balance plug, the sealing gasket is stacked on a lower side of the balance plug, the rigid gasket is stacked on a lower side of the sealing gasket, the upper spring abuts against an upper side of the balance plug and a top surface of the balance cavity, and the lower spring is supported between the rigid gasket and the cavity bottom wall.

12. The balance explosion-proof valve according to claim 11, wherein the balance plug comprises a balance plug body and an extension rod, an outer diameter of the balance plug body is less than an inner diameter of the balance cavity, the extension rod extends downward from the balance plug body, via holes are respectively formed in a middle portion of the sealing gasket and a middle portion of the rigid gasket, the sealing gasket and the rigid gasket are sleeved on the extension rod through the via holes, an inner diameter of each of the via holes is greater than an outer diameter of the extension rod, the sealing gasket is made from a flexible material, and an upper surface of the sealing gasket is attached to a lower end surface of the guide rod for sealing.

13. The balance explosion-proof valve according to claim 9, wherein the guide rod and the piston are of an integrated structure, a threaded hole penetrates through the inner concave cavity of the piston, a connecting head screwed with the threaded hole is disposed on a top portion of the guide rod, a bottom portion of the guide rod is recessed to form the balance cavity, the central hole communicates the waterproof breathable membrane with the balance cavity.

14. A balance explosion-proof valve, comprising:
a valve body;
a pressure relief assembly assembled on an upper side of the valve body; and
an air pressure balance assembly assembled on a lower side of the pressure relief assembly;
wherein the valve body comprises an outer ring body, an inner ring body, and connecting arms, wherein the connecting arms are connected to an inner surface of the outer ring body and an outer surface of the inner ring body, pressure relief holes are defined between the outer ring body and the inner ring body, a central sleeve hole is defined in the inner ring body, and the central sleeve hole penetrates through the inner ring body in a vertical direction;
wherein the pressure relief assembly comprises a piston pressed against a surface of the outer ring body, a waterproof breathable membrane, and an upper cover plate covering the waterproof breathable membrane;
wherein a periphery of the waterproof breathable membrane is coupled to the piston, the air pressure balance assembly comprises a guide rod connected to a lower side of the piston, a lower plugging cover connected to a lower end of the guide rod, and a balance valve;
wherein the balance valve is mounted in the guide rod and the lower plugging cover, a central hole is defined in the guide rod and penetrates through the guide rod in the vertical direction, the central hole is communicated with the waterproof breathable membrane, an outer protruding ring protrudes from a periphery of the lower plugging cover in the radial direction, a pressure relief spring is sleeved on an outer side of the guide rod, and the pressure relief spring is supported between the inner ring body and the outer protruding ring.

15. The balance explosion-proof valve according to claim 14, wherein the lower end of the guide rod is hollow and defines a balance cavity extending upward, an upper end of the lower plugging cover is hollow and defines a plugging cover cavity extending downward, the balance valve is assembled in the balance cavity and the plugging cover cavity, and the balance valve is movable up and down under an action of air pressure.

16. The balance explosion-proof valve according to claim 15, wherein a threaded portion is disposed on a periphery of the lower end of the guide rod, and the lower plugging cover further comprises a cavity outer wall surrounding the plugging cover cavity, a cavity bottom wall, and a through hole penetrating through the cavity bottom wall in the vertical direction;
wherein a threaded portion is disposed on an inner wall surface of an upper end of the plugging cover cavity, the threaded portion of the lower plugging cover is screwed with the threaded portion on the periphery of the lower end of the guide rod, and the outer protruding ring protrudes outward from a lower end of the cavity outer wall in a radial direction.

17. The balance explosion-proof valve according to claim 16, wherein the balance valve comprises a balance plug, a sealing gasket, a rigid gasket, an upper spring, and a lower spring, wherein an outer diameter of the sealing gasket is greater than a diameter of the balance plug, the sealing gasket is stacked on a lower side of the balance plug, the rigid gasket is stacked on a lower side of the sealing gasket, the upper spring abuts against an upper side of the balance plug and a top surface of the balance cavity, and the lower spring is supported between the rigid gasket and the cavity bottom wall.

18. The balance explosion-proof valve according to claim 17, wherein the balance plug comprises a balance plug body and an extension rod, an outer diameter of the balance plug body is less than an inner diameter of the balance cavity, the extension rod extends downward from the balance plug body, via holes are respectively formed in a middle portion of the sealing gasket and a middle portion of the rigid gasket, the sealing gasket and the rigid gasket are sleeved on the extension rod through the via holes, an inner diameter of each of the via holes is greater than an outer diameter of the extension rod, the sealing gasket is made from a flexible material, and an upper surface of the sealing gasket is attached to a lower end surface of the guide rod to be sealed together.

19. A balance explosion-proof valve, comprising:
a valve body;
a pressure relief assembly assembled on an upper side of the valve body; and
an air pressure balance assembly assembled on a lower side of the pressure relief assembly;
wherein the valve body comprises an outer ring body, an inner ring body, and connecting arms, wherein the connecting arms are connected to an inner surface of the outer ring body and an outer surface of the inner ring body, pressure relief holes are defined between the outer ring body and the inner ring body, a central sleeve hole is defined in the inner ring body, and the central sleeve hole penetrates through the inner ring body in a vertical direction;
wherein the pressure relief assembly comprises a piston pressed against a surface of the outer ring body, a waterproof breathable membrane, and an upper cover plate covering the waterproof breathable membrane;
wherein a periphery of the waterproof breathable membrane is connected to the piston, the air pressure balance assembly is mounted on a lower side of the piston and passes through the central sleeve hole, and the piston comprises an inner concave cavity, a pressing step, and an outer ring portion;
wherein the pressing step protrudes upward from a periphery of the inner concave cavity, the outer ring portion protrudes upward from an outer edge of the pressing step, the periphery of the waterproof breathable membrane is fixed to the pressing step and covers the inner concave cavity, a bottom surface of the outer ring portion is pressed against a first sealing ring disposed on the surface of the outer ring body, the upper cover plate defines vent grooves corresponding to the outer ring portion, the vent grooves communicate the waterproof breathable membrane with an outside.

20. The balance explosion-proof valve according to claim 19, wherein a lower protruding portion is formed on a periphery of the upper cover plate, the vent grooves penetrate through the lower protruding portion in a radial direction, a lower surface of the lower protruding portion is bonded to a surface of the outer ring portion, the bottom surface of the lower protruding portion forms rough surfaces, and the bottom surface of the lower protruding portion is configured to accommodate an adhesive and is bonded to the surface of the outer ring portion.
